(19) United States
(12) Patent Application Publication
(10) Pub. No.: US 2007/0047410 A1
(43) Pub. Date: Mar. 1, 2007

(54) Methods for reducing startup time of optical disc drive and apparatuses thereof

(76) Inventors: Chih-Yuan Chen, Hsin-Chu City (TW); Ching-Ning Chiu, Hsin-Chu Hsien (TW)

Correspondence Address: NORTH AMERICA INTELLECTUAL PROPERTY CORPORATION, P.O. BOX 506, MERRIFIELD, VA, 22116, US

(21) Appl. No.: 11/162,075

(22) Filed: Aug. 28, 2005

(51) Int. Cl. G11B 7/00

(52) U.S. Cl. 369/53.2

(57) ABSTRACT

An optical disc drive with reduced startup time. The optical disc drive includes an instruction-receiving interface, a type-discriminating unit, and a controller. The instruction-receiving interface receives a user instruction from a user, wherein the user instruction indicates the type of an optical disc loaded into the optical disc drive. The type-discriminating unit discriminates the type of the optical disc according to the user instruction. The controller controls the optical disc drive to access the optical disc according to the discriminated type of the optical disc.

### BACKGROUND

The present invention relates to optical disc drives, and more particularly, to methods and related apparatuses for reducing a startup time of an optical disc drive loaded with an optical disc.

Optical discs are a popular media for storing large amounts of data. Compact disc (CD), super audio compact disc (SACD), digital versatile disc (DVD), high definition DVD (HD DVD), and Blu-ray disc (BD) are examples of commonly seen optical discs. The capability of recognizing and accessing various types of optical discs has become one of the basic requirements for an optical disc drive. For this reason, after an optical disc is loaded into an optical disc drive, the optical disc drive has to discriminate the type of the optical disc correctly during a startup process in order to access the data recorded on the optical disc.

There have been proposed several methods for an optical disc drive to discriminate the type of an optical disc automatically during a startup process. For example, in U.S. Pat. No. 5,859,822, an optical disc player capable of recognizing and accessing various types of optical discs is disclosed. The optical disc player includes a first light source for reproducing data from a first type of optical discs and a second light source for reproducing data from a second type of optical discs, wherein the second type of optical discs has a recording density higher than that of the first type of optical discs. For an optical disc loaded into the optical disc player, if it is possible to reproduce a signal from the optical disc by the first light source, the optical disc is identified as the first type. If it is impossible to reproduce a signal from the optical disc by the first light source, the optical disc is identified as the second type.

Generally speaking, the automatic disc type discriminating methods of the related art discriminate the disc type through examining optical characteristics of the optical disc. An exemplary optical characteristic is derived by detecting reflected signals from the optical disc when various laser power levels are emitted onto the optical disc. If the optical disc is recognized as having optical characteristics supposed to be possessed by a specific disc type, the optical disc drive can then determine that the optical disc belongs to that specific disc type.

As mentioned before, an optical disc drive is more favorable if designed to be capable of processing as many different types of optical discs as possible. The more disc types the optical disc drive is capable of processing, the more complicated the automatic discriminating process will be. The complicated disc type discriminating process not only increases the startup time of the optical disc drive, but also degrades the overall performance of the optical disc drive.

### SUMMARY OF THE INVENTION

Methods and related apparatuses for reducing a startup time of an optical disc drive loaded with an optical disc are provided. Some embodiments of the method for reducing the startup time comprise receiving a user instruction, and discriminating the type of the optical disc according to the received user instruction.

In some embodiments, the optical disc drive comprises a pickup head, and the corresponding disc discrimination method comprises receiving a user instruction, discriminating the type of the optical disc according to the received user instruction, and controlling the pickup head to access the optical disc according to the discriminated type of the optical disc.

Some embodiments of the method for reducing the startup time comprise determining a searching order adaptively, and examining whether the type of the optical disc is the same as any type of the searching order in sequence until the type of the optical disc is successfully discriminated.

Some embodiments of the optical disc drive comprises an instruction-receiving interface for receiving a user instruction, and a type-discriminating unit coupled to the instruction-receiving interface for discriminating the type of the optical disc loaded into the optical disc drive according to the user instruction.

Some embodiments of the optical disc drive comprises a pickup head for accessing an optical disc loaded into an optical disc drive and a controller coupled to the pickup head for determining a searching order adaptively and controlling the pickup head to examine the type of the optical disc in accordance with the searching order until the type of the optical disc is successfully discriminated.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows a schematic diagram of an optical disc drive according to an embodiment.

FIG. 2, FIG. 3, FIG. 4, and FIG. 5 show flowcharts illustrating how the type of the optical disc loaded into the optical disc drive is discriminated during the startup process according to several embodiments.

### DETAILED DESCRIPTION

When a user loads an optical disc into an optical disc drive for data recording or reproduction, during a startup process the optical disc drive may take a significant period of time for recognizing the loaded disc if it supports a large number of disc types. However, it is likely that the user already knows which type the optical disc belongs to. With this idea in mind, before the optical disc drive tries to determine the type of the optical disc automatically, some embodiments allow a user to provide information to the optical disc drive regarding the disc type of the loaded optical disc. The optical disc drive discriminates the type of the optical disc according to the provided information without initiating an automatic disc type discriminating process. The startup time required for executing an automatic disc type discriminating process is therefore conserved.

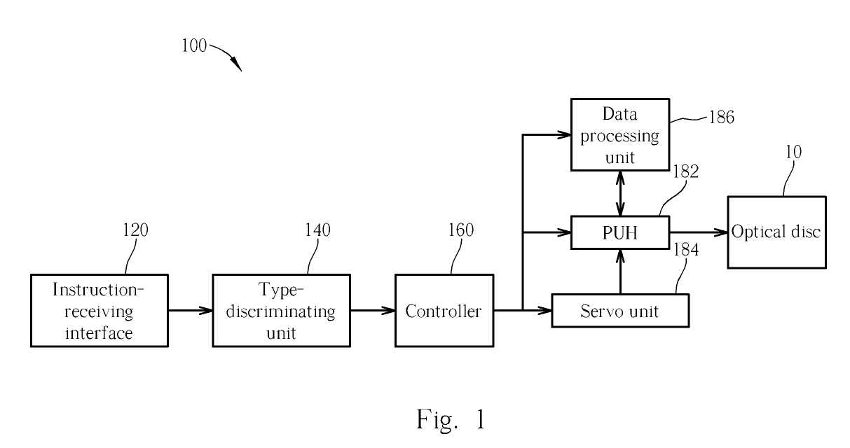

FIG. 1 shows a schematic diagram of an optical disc drive according to an embodiment. The optical disc drive 100 includes an instruction-receiving interface 120, a type-discriminating unit 140, a controller 160, a pickup head (PUH) 182, a servo unit 184, and a data processing unit 186. The optical disc drive 100 is loaded with an optical disc 10 that is going to be assessed.

The instruction-receiving interface 120 of the optical disc drive 100 receives a user instruction from a user. As mentioned, since the user usually knows the type of the optical disc 10 in advance, the user may give an instruction indicating the disc type to the optical disc drive 100 through the instruction-receiving interface 120. For example, the instruction-receiving interface 120 may be implemented by adding a knob on the casing of the optical disc drive 100. The user gives the user instruction to the optical disc drive 100 by turning the knob to a specific position corresponding to one of the optical disc types. A signal is then generated according to the knob position and transmitted to the type-discriminating unit 140 to report the received user instruction. The instruction-receiving interface 120 may also be implemented by adding a single button, a set of buttons, or a touch panel on the casing of optical disc drive 100 for receiving the user instruction. If there is a remote control being provided as an accessory of the optical disc drive 100 for controlling the optical disc drive 100, the instruction-receiving interface 120 can be implemented by a remote control receiver set on the casing of the optical disc drive 100. The user gives the user instruction concerning the type of the optical disc 10 through the remote control; the remote control then transmits the user instruction to the remote control receiver 120 by means of sending out a signal representing the user instruction. Besides, if the optical disc drive 100 is equipped with a host interface interconnecting the optical disc drive 100 and an external host, the instruction-receiving interface 120 may be implemented by the host interface. The user gives the user instruction concerning the type of the optical disc 10 through an input interface of the external host, and then the external host transmits the user instruction to the instruction-receiving interface 120 by sending out a signal representing the user instruction to the instruction-receiving interface 120.

The type-discriminating unit 140 is coupled to the instruction-receiving interface 120, and discriminates the type of the optical disc 10 according to the user instruction received by the instruction-receiving interface 120. The type-discriminating unit 140 then informs the controller 160 with the discriminated type of the optical disc 10.

The controller 160 is a unit that controls the operations of the optical disc drive 100. The controller 160 may properly control the optical disc drive 100 to access the optical disc 10 only if the disc type is accurately discriminated. In other words, in order to properly access the optical disc 10, the controller 160 must control the operations of the pickup head 182, the servo unit 184, and the data processing unit 186 according to the accurately discriminated optical disc type. More specifically, according to the discriminated type of the optical disc 10, the controller 160 may control the pickup head 182 to emit a laser beam with an appropriate wavelength and power level onto the optical disc 10 and to utilize an object lens having an appropriate numerical aperture (NA). For example, if the optical disc 10 is determined to be a CD, the pickup head 182 is controlled to emit an infrared laser with a wavelength of 780 nm and to utilize an object lens having an NA of 0.45. If the optical disc 10 is determined to be a DVD, the pickup head 182 is controlled to emit a red laser with a wavelength of 650 nm and to utilize an object lens having an NA of 0.65. If the optical disc 10 is determined to be a BD, the pickup head 182 is controlled to emit a blue laser with a wavelength of 405 nm and to utilize an object lens having an NA of 0.85.

In addition, the controller 160 may also inform the servo unit 184 and the data processing unit 186 with the discriminated type of the optical disc 10. According to the discriminated type of the optical disc 10, the servo unit 184 may adequately perform the servo control process, and the data processing unit 186 may also determine the modulation/demodulation scheme (for example, EFM or EFM+) is going to be applied in the data recording or data reproduction process.

Sometimes the user instruction provided by the user of the optical disc drive 100 might be wrong and does not match the actual type of the optical disc 10. If this happens, the optical disc drive 100 can further discriminate the disc type through other means. For example, the controller 160 may initiate an automatic disc type discriminating process to determine the type of the optical disc 10. Besides, sometimes the user tends to use the optical disc drive 100 to read from or write on the same type of optical discs successively. It is likely that the type of the optical disc 10 is the same as the type of an optical disc previously accessed by the optical disc drive 100. For example, a user may watch a series of drama recorded on a number of DVD-ROM discs with a DVD player capable of reading various disc types, so once the DVD player discriminates the disc type of a currently loaded disc belongs to DVD-ROM, the subsequent optical discs are most likely to be DVD-ROM discs. Another example is when a user only bought CD-RW discs for data storage, and the user's DVD recorder is capable of reading and writing various disc types. It is probable that the DVD recorder will repeatedly be loaded with CD-RW discs instead of discs of other types. Hence, in some embodiments, the optical disc drive may store the disc type of a previously accessed disc, and firstly tests if the currently loaded disc matches the stored disc type when initiating the automatic disc type discriminating process. Besides, sometimes the user tends to use the optical disc drive to read from or write on the some types of optical discs more frequently than other types. Hence, it is also likely that the type of the optical disc is the same as a most frequently accessed disc type of the optical disc drive. In some embodiments, the optical disc drive may store the most frequently accessed disc type of the optical disc drive, and firstly tests if the currently loaded disc matches the stored disc type when initiating the automatic disc type discriminating process.

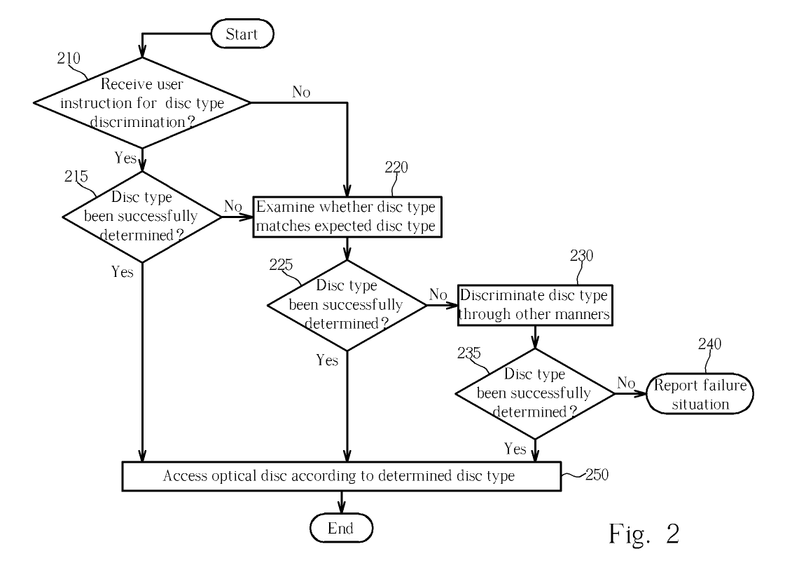

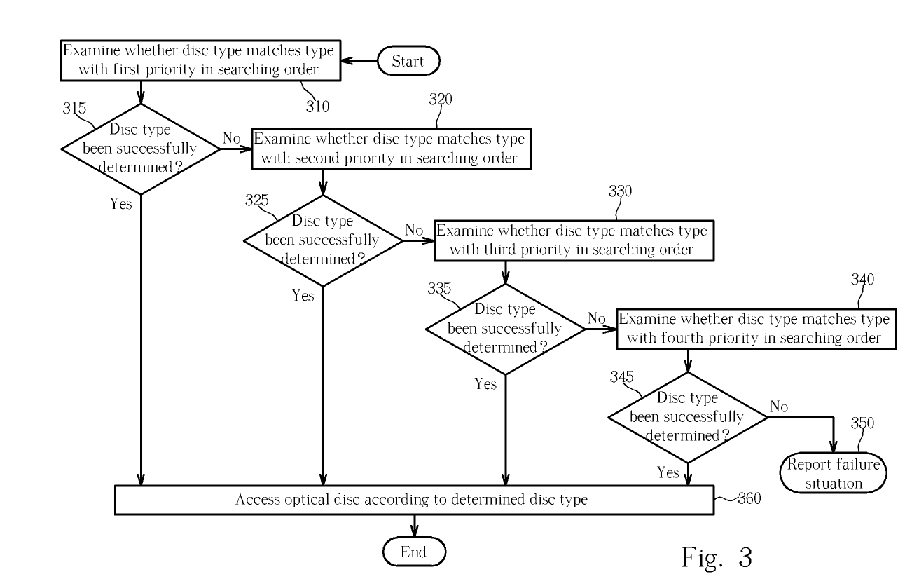

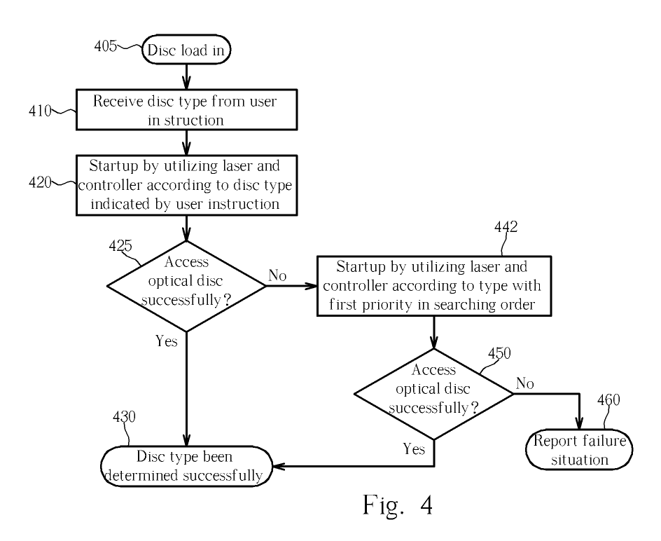

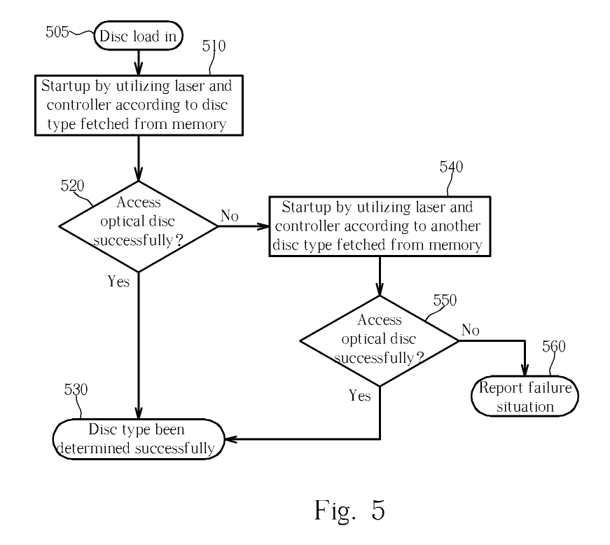

FIG. 2 shows a flowchart illustrating how the type of an optical disc loaded into an optical disc drive is discriminated in a startup process according to an embodiment. In step 210, the optical disc drive checks if a user instruction concerning the type of the optical disc is received and the optical disc drive tries to access the optical disc according to the received user instruction. If the user instruction is received timely and the type of the optical disc is successfully discriminated according to the received user instruction, step 250 is performed. Otherwise, if the user instruction is not timely received, an automatic disc type discriminating process is initiated by performing step 220. In step 220, the optical disc drive examines whether the type of the optical disc matches an expected disc type. As mentioned, since the type of the currently loaded disc is likely to be the same as the previously accessed disc type or the most frequently accessed disc type of the optical disc drive, herein the “expected disc type” is set to be one of the two probable types. If it is found that the type of the optical disc matches the expected disc type, step 250 is performed; otherwise, step 230 is performed. In step 230, the optical disc drive tries to discriminate the type of the optical disc through other manners, such as examining whether the type of the optical disc matches other remaining unexamined disc type. Step 230 may include those automatic discriminating processes typically implemented in the optical disc drive, for example, detecting a reflected light by emitting a laser beam onto the disc. Similarly, if the type of the optical disc is successfully discriminated in step 230, step 250 is performed; otherwise, step 240 is performed. When step 240 is performed, it means that the optical disc drive has failed to discriminate the type of the optical disc, the failure situation is therefore reported to the user of the optical disc drive or reported to the external host interconnected with the optical disc drive. In step 250, since the type of the optical disc is successfully discriminated, the optical disc drive can access the optical disc according to the discriminated type of the optical disc.

In some other embodiments, the optical disc drive may adaptively establish a searching order for determining which disc type should be tested first, in order to reduce the time required in the automatic disc type determining process to find the right disc type. The searching order places the most probable disc type, such as the disc type of a previously accessed disc, prior to other disc types. The type priority in the searching order may be determined according to user inputted instructions. For example, a user who is fond of watching motion video recorded on DVD-ROM discs can give instructions to his DVD player capable of accessing different types of discs to let DVD-ROM become the type with the first priority in the searching order. Each time a DVD-ROM disc is loaded into the DVD player, it can be recognized swiftly.

The searching order can also be determined according to a usage history including statistics corresponding to previously accessed discs of the optical disc drive, wherein the usage history is adaptively maintained by the optical disc drive. For example, the optical disc drive accumulates the usage frequency for each disc type based on the history of N previously accessed discs, and the automatic disc type determining process begins searching the disc type which is most frequently being loaded into the optical disc drive.

For example, according to a specific searching order, the optical disc drive may first examine whether the optical disc is a BD disc, then HD-DVD, DVD-R/RW, and lastly checks whether the optical disc is a CD-R/RW disc. FIG. 3 shows a flowchart illustrating how the type of the optical disc loaded into the optical disc drive is discriminated in a startup process according to the specific searching order. In step 310, the optical disc drive examines whether the type of the optical disc is the same as the disc type with the first priority in the searching order, herein the disc type is BD in this example. If a matched result is generated, step 360 is performed; otherwise, step 320 is performed. Similarly, in steps 320, 330, and 340, the optical disc drive examines whether the type of the optical disc matches the disc types with the second priority, third priority, and fourth priority in the searching order, respectively. In this example the disc types with the second priority, third priority, and fourth priority in the searching order are HD-DVD, DVD-R/RW, and CD-R/RW, respectively. If a matched result is generated in any of the steps, step 360 is performed; otherwise, if all of these steps generate unmatched results, step 350 is performed. When step 350 is performed, it means that the optical disc drive has failed to discriminate the type of the optical disc using the preset searching order, the failure situation is therefore reported to the user of the optical disc drive or reported to the external host interconnected with the optical disc drive. The optical disc drive may try the remaining disc type and if none of the disc type matches the loaded disc, the optical disc drive may notify the user the loaded disc cannot be accessed. In step 360, since the type of the optical disc is successfully discriminated, the optical disc drive can access the optical disc according to the discriminated type of the optical disc.

FIG. 4 shows an exemplary flowchart illustrating how an embodiment identifies the type of an optical disc during a startup process. The flowchart starts after the optical disc that is going to be accessed is loaded in the optical disc drive. In step 410, the optical disc drive receives a disc type from a user instruction. The disc type, which is indicated by the user instruction, is set by a user before the optical disc is loaded in the optical disc drive. In step 420, the optical disc drive startups by utilizing its laser and controller according to the disc type indicated by the user instruction. Alternatively, the optical disc can also fetch a previously accessed disc type from a memory of the optical disc drive in step 410, and startup in step 420 by utilizing its laser and controller according to the previously accessed disc type that is fetched from the memory. If the optical disc drive can successfully access the optical disc in step 420, it means that the disc type has been determined successfully. If the optical disc drive cannot access the optical disc successfully in step 420, step 440 will be performed. In step 440, the optical disc drive tries to startup by utilizing its laser and controller according to a type that has a highest (i.e. first) priority in a searching order. Alternatively, in step 440 the optical disc drive can also try to startup through other automatic disc type discriminating methods, such as discriminating the disc type through examining the reflectivity of the optical disc. If the optical disc drive can successfully access the optical disc in step 440, it means that the disc type has been determined successfully, otherwise step 460 will be performed and the failure situation is reported to the user of the optical disc drive or reported to the external host interconnected with the optical disc drive.

FIG. 5 shows an exemplary flowchart illustrating how an embodiment identifies the type of an optical disc during a startup process. The flowchart starts after the optical disc that is going to be accessed is loaded in the optical disc drive. In step 510, the optical disc drive startups by utilizing its laser and controller according to a possible disc type fetched from a memory. The memory may be utilized to memorize a previously accessed disc type and/or a disc type searching order. Either the previously accessed disc type or a type having a highest (i.e. first) priority in the disc type searching order can be fetched form the memory and be utilized as the possible disc type in step 510. If the optical disc drive can successfully access the optical disc in step 510, it means that the disc type has been determined successfully. If the optical disc drive cannot access the optical disc successfully in step 510, step 540 will be performed. In step 540, the optical disc drive tries to startup by utilizing its laser and controller according to another possible disc type fetched from the memory. For example, the possible disc type utilized in step 540 can be a type having a second priority in the disc type searching order memorized by the memory. Alternatively, in step 540 the optical disc drive can also try to startup through other automatic disc type discriminating methods, such as discriminating the disc type through examining the reflectivity of the optical disc. If the optical disc drive can successfully access the optical disc in step 540, it means that the disc type has been determined successfully, otherwise step 560 will be performed and the failure situation is reported to the user of the optical disc drive or reported to the external host interconnected with the optical disc drive.

The embodiments of the present invention not only can be utilized to determine whether an optical disc is a CD, an SACD, a DVD, an HD DVD, or a BD, but it can also be utilized to determine whether the optical disc is a single layer disc, a dual layer disc, or a multi-layer disc, or be utilized to determine whether the optical disc is a recordable (+R/−R) disc, a rewritable (+RW/−RW) disc, a read-only-memory (ROM) disc, or a random access memory (RAM) disc.

Certain terms are used throughout the description and the following claims to refer to particular system components. As one skilled in the art will appreciate, consumer electronic equipment manufacturers may refer to a component by different names. This document does not intend to distinguish between components that differ in name but not function. In the discussion and in the following claims, the terms “including” and “comprising” are used in an open-ended fashion, and thus should be interpreted to mean “including, but not limited to . . . ”. Also, the term “couple” or “couples” is intended to mean either an indirect or direct electrical connection. Thus, if a first device couples to a second device, that connection may be through a direct electrical connection, or through an indirect electrical connection via other devices and connections.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for reducing a startup time of an optical disc drive loaded with an optical disc, the method comprising:
receiving a user instruction; and
discriminating a type of the optical disc according to the received user instruction.

2. The method of claim 1, wherein the user instruction is provided to the optical disc drive through a knob, a button, a touch panel, a remote control receiver, or a host interface.

3. The method of claim 1, further comprising:
if the type of the optical disc is not successfully discriminated by the optical disc drive according to the received user instruction, examining whether the type of the optical disc is the same as a previously accessed disc type or a most frequently accessed disc type.

4. The method of claim 1, further comprising:
if the type of the optical disc is not successfully discriminated by the optical disc drive according to the received user instruction, examining the type of the optical disc in accordance with a searching order until the type of the optical disc is successfully discriminated.

5. The method of claim 4, wherein the searching order is determined according to a user input instruction.

6. The method of claim 4, wherein the searching order is determined according to a usage history based on statistics of previously accessed discs, and the usage history is maintained by the optical disc drive.

7. The method of claim 6, wherein according to the usage history, a type with a first priority in the searching order is determined according to a previously accessed disc type or a most frequently accessed disc type of the optical disc drive.

8. The method of claim 1, wherein the type of the optical disc comprises CD, SACD, DVD, HD DVD, or BD.

9. The method of claim 1, wherein the step of discriminating the type of the optical disc comprises:
determining the optical disc to be a single layer disc, a dual layer disc, or a multi-layer disc according to the received user instruction.

10. The method of claim 1, further comprising:
controlling the optical disc drive and accessing the optical disc according to the discriminated type of the optical disc.

11. An optical disc drive comprising:
an instruction-receiving interface for receiving a user instruction; and
a type-discriminating unit coupled to the instruction-receiving interface for discriminating a type of an optical disc loaded into the optical disc drive according to the user instruction.

12. The optical disc drive of claim 11, wherein the instruction-receiving interface comprises a knob, a button, a touch panel, a host interface, or a remote control receiver for receiving the user instruction.

13. The optical disc drive of claim 11, further comprising:
a controller coupled to the type-discriminating unit for controlling the optical disc drive to access the optical disc according to the discriminated type of the optical disc.

14. The optical disc drive of claim 13, wherein if the type of the optical disc is not successfully discriminated by the type-discriminating unit according to the user instruction, the controller further controls the optical disc drive to examine whether the type of the optical disc is the same as a previously accessed disc type or a most frequently accessed disc type.

15. The optical disc drive of claim 13, wherein if the type of the optical disc is not successfully discriminated by the type-discriminating unit according to the user instruction, the controller further controls the optical disc drive to examine the type of the optical disc in accordance with a searching order in sequence until the type of the optical disc is successfully discriminated.

16. The optical disc drive of claim 15, wherein the searching order is determined according to a user input instruction.

17. The optical disc drive of claim 15, wherein the searching order is determined according to a usage history based on statistics of previously accessed discs, and the usage history is maintained by the optical disc drive.

18. The optical disc drive of claim 17, wherein according to the usage history, a type with a first priority in the searching order is determined according to a previously accessed disc type or a most frequently accessed disc type.

19. The optical disc drive of claim 11, wherein the type of the optical disc comprises CD, SACD, DVD, HD DVD, or BD.

20. The optical disc drive of claim 11, wherein the type-discriminating unit determines the optical disc to be a single layer disc, a dual layer disc, or a multi-layer disc according to the user instruction.

21. A method for reducing a startup time of an optical disc drive loaded with an optical disc, the method comprising:
determining a searching order adaptively; and
examining the type of the optical disc in accordance with the searching order until the type of the optical disc is successfully discriminated.

22. The method of claim 21, wherein the searching order is determined according to a user input instruction.

23. The method of claim 21, wherein the searching order is determined according to a usage history based on statistics of previously accessed discs, and the usage history is maintained by the optical disc drive.

24. The method of claim 23, wherein a type having a first priority in the searching order is determined according to a previously accessed disc type or a most frequently accessed disc type.

25. An optical disc drive comprising:
a pickup head for accessing an optical disc loaded into an optical disc drive; and
a controller coupled to the pickup head for determining a searching order adaptively and controlling the pickup head to examine the type of the optical disc in accordance with the searching order until the type of the optical disc is successfully discriminated.

26. The optical disc drive of claim 25, wherein the controller determines the searching order according to a user input instruction.

27. The optical disc drive of claim 25, wherein the controller determines the searching order according to a usage history based on statistics of previously accessed discs, and the usage history is maintained by the optical disc drive.

28. The optical disc drive of claim 27, wherein a type having a first priority in the searching order is determined according to a previously accessed disc type or a most frequently accessed disc type.
